(19) United States
(12) Patent Application Publication
(10) Pub. No.: US 2020/0086525 A1
(43) Pub. Date: Mar. 19, 2020

(54) MACHINE AND METHOD FOR COMPACTING A POWDER MATERIAL

(71) Applicant: SACMI COOPERATIVA MECCANICI IMOLA SOCIETÀ COOPERATIVA, Imola (IT)

(72) Inventors: Marco SALIERI, Imola (IT); Alan BABINI, Imola (IT); Mauro BERTOZZI, Imola (IT)

(21) Appl. No.: 16/572,832

(22) Filed: Sep. 17, 2019

(30) Foreign Application Priority Data
Sep. 17, 2018 (IT) 102018000008650

(51) Int. Cl. B28B 3/12; B28B 13/02

(52) U.S. Cl. CPC B28B 3/123; B28B 13/0295

(57) ABSTRACT

A machine and method for compacting a powder material comprising ceramic powder; a layer of non-compacted powder material is conveyed to a compacting device, which enables a layer of compacted powder material to be obtained; the machine comprises a conveyor belt for carrying the powder material from an input station, in the area of which a feed assembly feeds the powder material to the conveyor assembly, to the compacting device; a straightening device is envisaged, which is designed for exerting a force to increase the flatness of the conveyor belt at least in the area of the input station.

### CROSS-REFERENCE TO RELATED APPLICATIONS

This patent application claims priority from Italian patent application no. 102018000008650 filed on Sep. 17, 2018, the entire disclosure of which is incorporated herein by reference.

### TECHNICAL FIELD

The present invention relates to a machine and a method for the compacting of powder material.

The present invention also relates to a plant and procedure for the production of ceramic articles.

### BACKGROUND OF THE INVENTION

In the field of ceramic articles production, the use of machines for compacting ceramic powder for the production of slabs, preferably thin ones (e.g. tiles), is well known.

This type of machine comprises a compacting device, designed to compact the powder material so as to obtain a layer of compacted powder material; a conveyor assembly for transporting the powder material from an input station to the compacting device; and a feeding assembly, which is designed to feed the powder material to the conveyor assembly at the input station. The conveyor assembly comprises a conveyor belt (particularly a metal one), on which the feeding assembly deposits the powder material when it is in use.

It has been observed that the slabs obtained have a thickness and/or density that is not always homogenous and/or an incorrect geometry. This phenomenon became more frequent once the conveyor belt had been used for a certain length of time.

The purpose of the present invention is to provide a machine and a method for compacting powder material and a plant and a procedure for the production of ceramic articles, which enable the drawbacks of the prior art to be overcome, at least in part, and which, at the same time, are easy and cheap to manufacture.

### SUMMARY

According to the present invention, a machine and a method for compacting powder material, and a plant and a procedure for the production of ceramic articles, are provided, as claimed in the independent claims that follow and, preferably, in any one of the claims directly or indirectly dependent on the independent claims.

### BRIEF DESCRIPTION OF THE FIGURES

The invention is described below with reference to the accompanying drawings which show some non-limiting embodiments of it, wherein:

FIG. 1 is a lateral and schematic view of a plant in accordance with the present invention;

FIG. 2 is a frontal and schematic view of a detail of one of the plant machines in FIG. 1;

FIG. 3 is a lateral and schematic view of the detail in FIG. 2;

FIG. 4 is a frontal and schematic view of a detail of a prior art machine;

FIG. 5 is a lateral and schematic view of the detail in FIG. 4;

FIG. 6 is a frontal and schematic view of an alternative detail to the detail in FIG. 2; and

FIG. 7 is a lateral and schematic view of the detail in FIG. 6.

### DETAILED DESCRIPTION

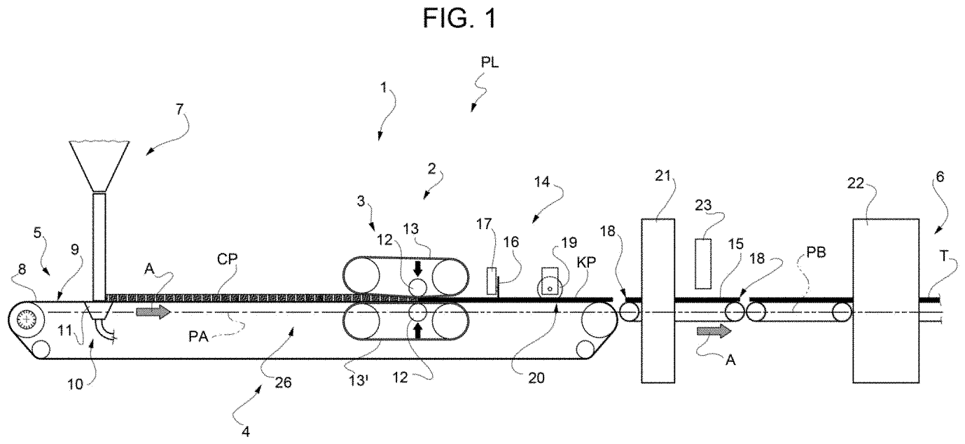

In FIG. 1, PL designates, as a whole, a plant for the manufacture of a ceramic article T. In particular, the ceramic article T is a tile or a slab.

Plant 1 comprises a machine 1 for compacting a powder material CP comprising ceramic powder (e.g. containing clays, sands, and/or feldspars). The machine 1 comprises a compacting device 2, which is arranged at a working station 3 and is designed to compact the ceramic powder CP so as to obtain a layer of compacted ceramic powder KP; a conveyor assembly 4 to transport the ceramic powder CP (in a substantially continuous manner) along a first portion PA of a given path (in a moving direction A) from an input station 5 to the working station 3 and the layer of compacted ceramic powder KP along a second portion PB of the given path from the working station 3 (to an output station 6); and a feeding assembly 7, which is designed to feed the ceramic powder CP to the conveyor assembly 4 at the input station 5.

In particular, the feeding assembly 7 feeds the ceramic powder to the conveyor assembly 4 in a substantially continuous manner.

In particular, the conveyor assembly 4 is also designed to support the powder material CP and the compacted powder material KP from below.

The conveyor assembly 4 comprises a conveyor belt 8. The feeding assembly 7 is designed to feed the powder material CP to (on) the conveyor belt 8 at the input station 5.

In particular, the conveyor belt 8 has a support surface 9 and is designed to transport (and to support) the powder material CP along (at least part of) the first portion PA. The feeding assembly 7 is designed to feed the powder material to the support surface 9.

The machine 1 comprises a straightening device 10, which comprises at least one sucking head 11, arranged at the input station 5 and designed to exert a force (in particular, by means of sucking) on the conveyor belt 8 to increase the flatness of the conveyor belt 8 (at least) at the input station 5.

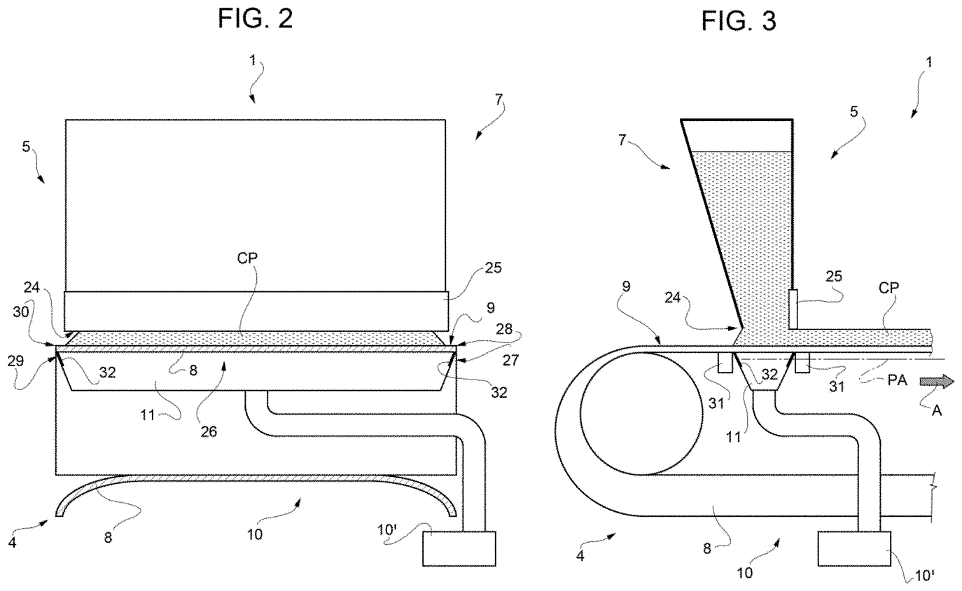

It has been experimentally observed that in this way each ceramic article T has, surprisingly, a homogeneous density and/or thickness as well as/or a correct geometry (FIGS. 2 and 3).

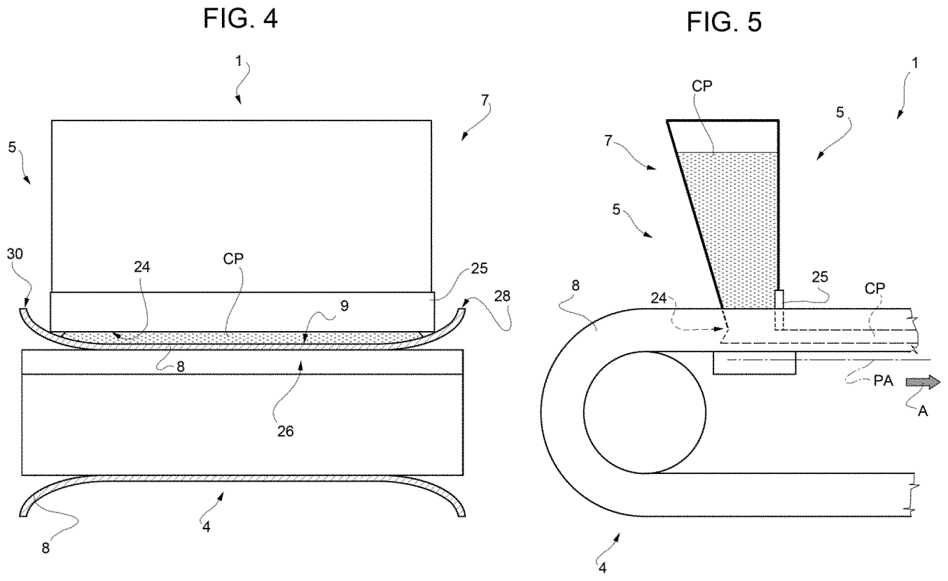

After having noted the above, it was also noted that (as shown in FIGS. 4 and 5), if this device is not implemented, the pressure belt 13 tends to deform (in particular, after a certain length of use). In this way (as more clearly shown in FIG. 4), some areas of the layer of ceramic powder CP (in particular, those closest to the longitudinal edges of the conveyor belt 4) are less thick (and, therefore, have less ceramic powder CP). The thickness of the powder material CP affects the density of the compacted product (the base article 15); this density is, in turn, correlated with the size and geometry of the ceramic article T (after firing).

In particular, in use, a pressure less than atmospheric pressure is created inside the sucking head 11. The difference in pressure means that the conveyor belt 8 is subjected to a vertical force that, by bending it, makes it flat at the feeding assembly 7, thus ensuring correct loading of the powder material CP on the conveyor belt 8 itself.

According to some non-limiting embodiments, the straightening device 10 comprises a sucking unit 10′ (in particular, a pump) and at least one conduit to connect the sucking unit 10′ to the sucking head 11.

In some cases, the straightening device 10 comprises a sensor (known and not shown) to detect the pressure set by the sucking unit 10′ and a control system (not shown) for emitting an alarm signal if the pressure detected is incorrect (too high).

Advantageously but not necessarily, the conveyor belt 8 comprises (at least) one metal material (more precisely, steel). In particular, the conveyor belt 8 is (mainly) made of metal material (more precisely, steel).

In some cases, the feeding assembly 7 (in particular, see FIG. 1) is designed to carry a layer of (non-compacted) ceramic powder CP to (onto) the conveyor belt 8 (at the input station 5); the compacting device 2 is designed to exert pressure on the layer of ceramic powder CP transverse (in particular, normal) to the support surface 9.

According to some non-limiting embodiments, the compacting device 2 comprises at least one compression roller 12 (in particular, two compression rollers 12 arranged on opposite bands—one above and one below—of the conveyor belt 8) for exerting pressure on the ceramic powder CP so as to compact the ceramic powder CP itself.

Although in FIG. 1 only two rollers 12 are shown, in accordance with some variants, it is also possible to provide a plurality of rollers 12 arranged above and below the conveyor belt 8, as described, for example, in patent EP1641607B1.

In particular, the compacting device 2 also comprises at least one actuator (in particular, a fluid-dynamic one—that is known and not shown) designed to push the compression roller 12 downwards and towards the conveyor assembly 4.

Advantageously (as in the embodiment shown in FIG. 1) but not necessarily, the compacting device 2 comprises a pressure belt 13.

In particular, the pressure belt 13 converges towards the conveyor belt 8 in the moving direction A in which the conveyor assembly 4 feeds the ceramic powder CP to the compacting device 2. In this way, pressure is exerted (from top to bottom) that gradually increases in the direction A on the ceramic powder CP so that it is compacted.

In particular, the pressure belt 13 is (mainly) made of metal (steel) so that it is not substantially deformed while pressure is exerted on the ceramic powder.

According to specific embodiments (such as that shown in FIG. 1), the compacting device also comprises an opposing belt 13′ that is arranged on the opposite side of the conveyor belt 8 (in particular, made of rubber or a similar material) with respect to the pressure belt 13 to work together with the conveyor belt 8 to provide an appropriate response to the force exerted downwards by the pressure belt 13. In these cases, in particular, the opposing belt 13′ is (mainly) made of metal (steel) so that it is not substantially deformed while pressure is exerted on the ceramic powder.

Advantageously but not necessarily, the opposing belt 13′ and the conveyor belt 8 coincide. In other words, the opposing belt 13′ is absent (and, in particular, the conveyor belt 8 is—mainly—made of metal—steel). In these cases, the conveyor belt 8 also performs the functions of the opposing belt 13′ (as described above).

Advantageously but not necessarily, the conveyor belt 8 ends at (the end of) the working station 3. In these cases, the conveyor assembly 4 comprises an additional belt for conveying (not shown), which is arranged immediately downstream of the compacting device 2 and is designed to advance the compacted ceramic powder KP (in the direction A) at a different speed (in particular, faster) than the speed at which the conveyor belt 11 conveys the ceramic powder CP to (and through) the working station 3. More precisely, the speed of the additional belt for conveying (not shown) is adapted to (corresponds to) the speed at which the compacted ceramic powder KP exits the compacting device 2.

As an alternative or in addition to the above, according to some non-limiting embodiments, the feeding assembly 7 is designed to bring a layer of (non-compacted) ceramic powder CP to (onto) the conveyor assembly 4 (more precisely, onto the conveyor belt 8), which is designed to feed the layer of ceramic powder CP to the compacting device 2 in the moving direction A.

According to some non-limiting embodiments, the plant PL also comprises a cutting assembly 14 for transversely cutting the layer of compacted ceramic powder KP so as to obtain a base article 15 (more precisely, a plurality of base articles 15; even more precisely, base slabs), which (each of which) is a portion of the layer of compacted powder KP. More in particular, the cutting assembly 14 is arranged along the portion PB of the given path (more in particular, downstream of the compacting device 2; even more particularly, between the working station 3 and the output station 6). In particular, the base articles 15 consist of compacted ceramic powder KP.

Advantageously but not necessarily, the conveyor assembly 4 is designed to feed the layer of compacted powder KP to the cutting assembly 14 and to transport the base article 15 downstream of the cutting assembly 14.

Advantageously, the cutting assembly 14 comprises a cutting blade 16, which is designed to enter into contact with the layer of compacted ceramic powder KP, in order to cut it, and a handling unit 17, to move the cutting blade 16 along a path that is diagonal to the direction A. In this way, it is possible to provide the base articles 15 with end edges 18 that are substantially perpendicular to the direction A while the layer of compacted ceramic powder KP is continuously advanced.

According to some embodiments (such as that shown in FIGS. 1 and 2), the cutting assembly 14 also comprises two additional blades 19, which are arranged on opposite sides of the portion PB and are designed to cut the layer of compacted ceramic powder KP and to define the lateral edges 20 of the base articles 15 substantially perpendicular to the edges 18 (and substantially parallel to the direction A). In some specific cases, the cutting assembly 14 is similar to that described in the patent application with publication number EP1415780.

According to some non-limiting embodiments, the plant PL also comprises a dryer 21 (FIG. 1) arranged along the second portion PB of the given path downstream from the compacting device 2 (more precisely, downstream from the cutting assembly 14).

According to some non-limiting embodiments, the plant 1 also comprises at least one firing kiln 22 for sintering (the layer of compacted powder KP of) the base article 15 so as to obtain the ceramic product T. In particular, the firing kiln 22 is arranged along the second portion PB of the given path downstream of the compacting device 2 (and downstream of the cutting assembly 14; in particular, also downstream of the dryer 21).

According to some non-limiting embodiments, a printing unit 23 may be provided to decorate the surface of at least a portion of the layer of compacted powder KP (in particular, of the base article 15).

Typically but not necessarily, the printing unit 23 is arranged upstream of the firing kiln 22 (and, in particular, downstream of the dryer 21).

In particular, the feeding assembly 7 has an output mouth 24 (see FIGS. 2 and 3 in particular), which faces the support surface 9 and through which, in use, the powder material CP passes to reach the support surface 9. According to some non-limiting embodiments, the machine (more particularly, the feeding unit 7) comprises a levelling device 25, designed to at least partially level the powder material CP on the conveyor belt 8 upstream of the working station 3 (and arranged along the first portion PA). In particular, the levelling device 25 is arranged at the input station 5. Advantageously, but not necessarily, the levelling device 25 at least partially delimits the output mouth 24 transversely to the moving direction A (downstream of the output mouth 24). More precisely, but not necessarily, the levelling device 25 is an edge (transverse—in particular perpendicular—to the direction A) of the output mouth 24.

According to specific and non-limiting embodiments, the levelling device 25 comprises (is) a plate (transverse—particularly perpendicular—to the direction A) e.g. made of metal or a suitable polymer (such as polyurethane).

In particular, the conveyor belt 8 is arranged between the sucking head 11 and the feeding assembly 7.

More particularly, the conveyor belt 8 is arranged between the sucking head 11 and the output mouth 24.

In particular, the conveyor belt 8 is arranged between the sucking head 11 and the levelling device 25.

Advantageously but not necessarily, the sucking head 11 extends transversely to the moving direction A.

According to some non-limiting embodiments, the conveyor belt 8 has an active portion 26 that extends longitudinally along (at least part of) the first portion PA of the given path.

In some non-limiting cases, the sucking head 11 extends transversely to the conveyor belt 8 (in particular, to the active portion 26) so as to present a first end 27 at a first longitudinal edge 28 of the conveyor belt 8 (in particular, of the active portion 26) and a second end 29 at a second longitudinal edge 30 (opposite to the longitudinal edge 28) of the conveyor belt 8 (in particular, of the active portion 26).

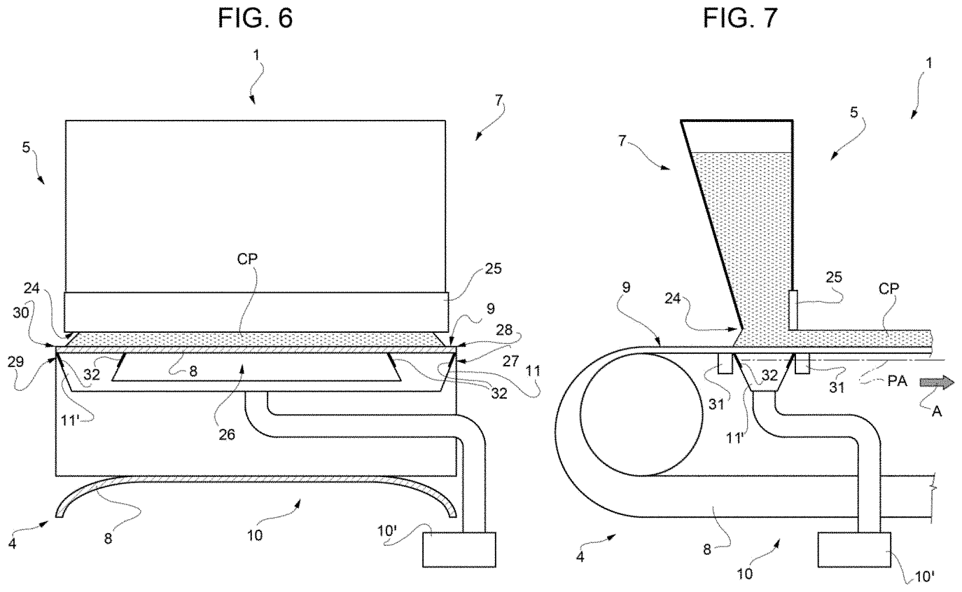

Alternatively (FIGS. 6 and 7), the sucking head 11 is arranged at the first longitudinal edge 28 (of the active portion 26). The straightening device 10 comprises an additional sucking head 11′ arranged at the second longitudinal edge 30 (of the active portion 26).

Advantageously but not necessarily (FIGS. 2, 3, 6, and 7), the straightening device 10 comprises at least one support 31, which (is arranged, in particular, on the opposite side of the conveyor belt 8 with respect to the feeding assembly 7—more particularly, immediately downstream and/or upstream of the sucking head 11 and) is designed to support the conveyor belt 8 downstream and/or upstream (with respect to the direction A) of the sucking head 11.

More precisely, but not necessarily, the support 31 is arranged (is designed to come) in contact with the conveyor belt 8 (in particular, with the surface of the conveyor belt 8 opposite to the support surface 9).

According to some non-limiting embodiments, the straightening device 10 comprises at least two supports 31, of which at least one is arranged (immediately) upstream of the sucking head 11 and at least one is arranged (immediately) downstream of the sucking head 11.

Advantageously but not necessarily, the sucking head 11 comprises an end gasket 32 (designed to come) in contact with the conveyor belt 8, in particular designed to come into contact with a further surface of the conveyor belt 8 opposite to the support surface 9. More particularly, the conveyor belt 8 is designed to slide on the gasket 32.

The gasket 32 enables a better seal, between the conveyor belt 8 and the sucking head 11, to be obtained.

In particular, the (framed) gasket 32 extends along the whole external profile of the sucking head 11 (more precisely, of the whole sucking opening of the sucking head 11).

Advantageously but not necessarily, the gasket 32 comprises a (is made of, in particular) rubber. According to some non-limiting embodiments, the gasket 32 comprises (is—mainly—made of, in particular) polyethylene terephthalate. According to some specifications and non-limiting embodiments, the gasket 32 comprises (is—mainly—made of, in particular) Ertalyte® PET-P.

A method for compacting a powder material CP comprising ceramic powder (e.g. powder containing clays, sands, and/or feldspars) is also provided.

The method comprises at least one compacting step, during which the powder material CP is compacted, at a working station 3, so as to obtain a layer of compacted powder material KP; a conveying step, during which the powder material CP is conveyed by means of a conveyor assembly 4 along a first portion PA of a given path from an input station 5 to the working station 3 and the layer of compacted powder material KP is conveyed from the working station 3 along a second portion PB of the given path; and a feeding step, during which the powder material CP is fed to (onto) a conveyor belt 8 of the conveyor assembly 4 at the input station 6 by means of a feeding assembly 7.

In particular, the conveying step and the feeding step are at least partially simultaneous.

The method also comprises a straightening step, during which a straightening device 10 is designed to exert a force by means of sucking on the conveyor belt 8 to increase the flatness of the conveyor belt 8 itself at least at the input station 5. The feeding step and the straightening step being at least partially simultaneous.

Advantageously but not necessarily, the method is implemented by a machine 1 as described above.

According to some non-limiting embodiments, the method comprises a levelling step, during which the powder material CP arranged on the conveyor belt 8 upstream of the working station 3 (in particular, at the input station 5) is at least partially leveled. In particular, the feeding step and the levelling step are at least partially simultaneous.

A procedure for the production of ceramic articles T is also provided. The procedure comprises a method for compacting a powder material CP in accordance with that described above. The procedure comprises a firing step, during which (at least) a portion of the layer of compacted powder material (KP) is fired.

In particular, the procedure is implemented by the plant PL.

Unless expressly indicated to the contrary, the contents of the references (articles, books, and patent applications etc.) cited in this text are herein recalled in full. In particular, the above-mentioned references are herein incorporated by reference.

1. A machine for compacting a powder material comprising ceramic powder; the machine comprising:
a compacting device, which is arranged at a working station and is designed to compact the powder material so as to obtain a layer of compacted powder material;
a conveyor assembly to transport the powder material along a first portion of a given path from an input station to the working station and the layer of compacted powder material from the working station along a second portion (of the given path; and
a feeding assembly, which is designed to feed the powder material (to the conveyor assembly at the input station;
wherein the conveyor assembly comprises a conveyor belt;
wherein the feeding assembly is designed to feed the powder material to the conveyor belt at the input station;
wherein the machine comprises a straightening device, which comprises at least one sucking head arranged in the area of the input station and designed to exert a force aimed at increasing the flatness of the conveyor belt at least at the input station.

2. The machine according to claim 1, wherein the conveyor belt comprises a metal material; in particular, the conveyor belt is mainly made of a metal material.

3. The machine according to claim 1, further comprising a levelling device arranged along the first portion and designed to at least partially level the powder material on the conveyor belt upstream of the working station.

4. The machine according to claim 1, wherein the conveyor belt has a support surface, onto which the feeding assembly is designed to feed the powder material;
wherein the feeding assembly has an output mouth, which faces the support surface and through which, in use, the powder material passes in order to reach the support surface.

5. The machine according to claim 4, wherein the conveyor assembly is designed to transport the powder material along the first portion in a moving direction;
wherein the machine further comprises a levelling device, which is designed to level the powder material on the conveyor belt upstream of the working station and at least partially delimits the output mouth transversely to the moving direction.

6. The machine according to claim 1, wherein the conveyor belt is arranged between the sucking head and the feeding assembly.

7. The machine according to claim 1, wherein the conveyor belt has an active portion, which extends longitudinally along at least part of the first portion of the given path; wherein said sucking head extends transversely to the active portion so as to have a first end in the area of a first longitudinal edge of the active portion and a second end in the area of a second longitudinal edge, opposite the first longitudinal edge of the active portion.

8. The machine according to claim 1, wherein the conveyor belt has an active portion, which extends longitudinally along at least part of the first portion of the given path;
said sucking head being arranged in the area of a first longitudinal edge of the active portion;
wherein the straightening device comprises a further sucking head arranged in the area of a second longitudinal edge of the active portion.

9. The machine according to claim 1, wherein the conveyor assembly is designed to transport the powder material along the first portion in a moving direction;
wherein the straightening device further comprises at least one support, which is designed to support the conveyor belt downstream and/or upstream of the sucking head.

10. The machine according to claim 1, wherein the sucking head comprises an end gasket) in contact with the conveyor belt.

11. A plant for the production of ceramic articles, the plant comprising:
at least one machine for compacting ceramic powder according to claim 1;
a cutting assembly to transversely cut the layer of compacted ceramic powder so as to obtain base articles, each having a portion of the layer of compacted ceramic powder; and
at least one firing kiln to sinter the compacted ceramic powder (of the base articles so as to obtain the ceramic articles.

12. A method for compacting a powder material comprising ceramic powder; the method comprising:
at least one compacting step, during which the powder material is compacted at a working station so as to obtain a layer of compacted powder material;
a conveying step, during which the powder material is conveyed, by means of a conveyor assembly, along a first portion of a given path from an input station to the working station and the layer of compacted powder material is conveyed from the working station along a second portion of the given path;
a feeding step, during which the powder material is fed to a conveyor belt of the conveyor assembly at the input station by means of a feeding assembly; and
a straightening step, during which a straightening device is designed to exert a force, through sucking, upon the conveyor belt in order to increase the flatness of the conveyor belt at least at the input station, wherein the feeding step and the straightening step are at least partially simultaneous.

13. The method according to claim 12 and implemented by a machine according to claim 1.

14. The method according to claim 12 further comprising a levelling step, during which the powder material arranged in the conveyor belt upstream of the working station is at least partially leveled, wherein the feeding step and the levelling step are at least partially simultaneous.

15. The method according to claim 12, wherein the conveying step and the feeding step are at least partially simultaneous.

16. A process for the production of ceramic articles; the process comprises a method for compacting a powder material according to claim 12; and
a firing step, during which at least a portion of the layer of compacted powder material is fired.
